(19) United States
(12) Patent Application Publication
(10) Pub. No.: US 2002/0178140 A1
(43) Pub. Date: Nov. 28, 2002

(54) Method for characterizing and storing data analyses in an analysis database

(76) Inventors: Donald Ernest Woodmansee, Simpsonville, SC (US); Thomas Koshy, Niskayuna, NY (US); Anand Tadepalli, Greenville, SC (US); Evelyn Varner, Cottekill, NY (US); William T. Tucker, Niskayuna, NY (US); Robert M. Witbeck JR., Greenville, SC (US); Gary Raymond Livingston, Clifton Park, NY (US)

Correspondence Address: NIXON & VANDERHYE P.C., 1100 North Glebe Road, 8th Floor, Arlington, VA, 22201, US

(21) Appl. No.: 09/864,286

(22) Filed: May 25, 2001

(51) Int. Cl. G06F 7/00

(52) U.S. Cl. 707/1

(57) ABSTRACT

A method of storing and recovering database analysis information including a) extracting data from a database system; b) processing the extracted data to produce sorted datasets; c) processing sorted datasets to produce graphical objects; d) processing the graphical objects to produce analysis objects; and e) storing the analysis objects as separate file records.

### FIELD OF INVENTION

This invention relates to database systems, more particularly, to a method for both conducting data analyses and preserving past analyses of large datasets for later recovery and automation of reanalysis at a later time with updated data.

### BACKGROUND OF THE INVENTION

Business people often base important decisions on analysis of computer data. Increasingly efficient and automatic mechanisms for collecting and inputting data into computer databases provide a treasure of data. For example, businesses can now efficiently collect detailed information concerning every acquisition, every expenditure, and every product sale—or monitor the lifetime and replacement of every component of complicated machines such as gas turbine engines. Often, the problem is not how to collect the data, but rather how to efficiently and effectively abstract and analyze collected data to provide the decision-maker with useful information.

The analysis process can often be time-consuming and labor-intensive, and can also require substantial expertise. For example, a human analyst may first need to develop a set of data filters or other criteria for selecting relevant information from the database. The resulting output of a database query might then be transferred to another application (e.g., a spreadsheet application) for examination, sorting and calculation if necessary. Those results (or selected subsets of those results) might then need to be transferred to still another application for statistical analysis—and those further results transferred to a still further application such as presentation software for report generation and charting.

If further results are needed for different or updated database, the entire process may need to be repeated. Typically, the final report or other presentation produced does not document the analysis process in enough detail to allow someone else to easily repeat the analysis. If the person who did the original analysis doesn't remember how he or she performed the analysis or has changed positions or is no longer with the enterprise, someone else may have to reconstruct the entire process from scratch—wasting substantial time by “reinveinting the wheel.”

Also, some of the administrative problems relate to approaches adopted to conduct data analysis for the first time, the conduct of repeat analysis with a new dataset, and the recovery of the business information presentation material generated as a result of such analyses. Performing original analysis on a large dataset may create administrative problems for an analyst with regards to manually manipulating the data from one application to another. The process of manually managing the transfer of information from one application to another may complicate the analysis process, and thus requires very close examination, supervision, and labeling.

Further, an analyst may be forced to keep track of not only the ranges included in the datasets, but also the specific analysis tools and procedures used to compute an analysis result. Keeping track of analysis tools and procedures information may be especially cumbersome when several data analyses are being conducted simultaneously, perhaps to determine which dataset and procedure provides the most accurate result. In such cases, an analyst may have to create manual records of dataset filter specifications, either as notes on paper, or as manually keyed computer files attached to the analyses result files.

In one approach, recovering results of prior analyses from a database includes recovering a presentation or a report made by an original analyst. This approach often fails as few enterprises have library mechanisms to capture and hold such analysis information, if they were indeed generated as complete reports at all. More often, a formal analysis report is not written because of the extra work effort required to generate such a report.

Lack of established mechanisms by an enterprise create the inability to provide auditable records of the analyses used by the enterprise in making business decisions. At best, these analyses are only trackable by listings of author and date, with possible additions of analysis topic and its scope. In one approach, design record books that are required to conform to ISO9000 standards store such information as, engineering design analysis and check sheets to document, thus establishing design procedures used in the design analysis. Similar procedures, however, are not true for data analysis used for business decisions when the quality consequences can be just as severe. In fact, many contractual service businesses require pro forma projections of future cash flows for reasons which include financial audits in order to provide an audit trail for current and past pricing decisions, as well as to provide set-aside funds in the event of higher debt liabilities.

In another approach, there exists a requirement for an entity to create a database of report file records, and manually index the records for later recovery in order to apply filters to the supplied indices. In another approach, an analyst creates the presentation assembly file outside the control of the software that prepared and loaded the analysis chart files into the analysis database. In this case, the analyst would then have to personally initiate the processes for loading the presentation assembly file to the analysis database.

In yet another approach, a presentation file is created under the control of the analysis database software engine.

The above approaches fail to teach or suggest using tracers/label descriptors to determine how a database is used, so that the analysis information may be recovered. Therefore, there is a need to provide an automated method to recover the past analyses from a database.

### SUMMARY OF THE INVENTION

Accordingly, the present invention relates to a method and apparatus for recovering past analyses of large datasets by capturing data filter information. Specifically, the present invention relates to a method of preserving database analysis for later recovery comprising (a) capturing database filter criteria as tracer labels for analysis conducted on a database; (b) passing the tracer labels through a series of computer applications used to perform the analysis; (c) maintaining the tracer labels in association with a presentation of the analysis; and (d) subsequently using the tracer labels to repeat the analysis.

In another embodiment, the method of the present invention may be used to process datasets that are communicated over the worldwide web, and using packet switching networks, such as, for example, Internet and Intranets.

In one aspect, a network server having a database system, the database system having datasets, the analysis performed on the datasets stored in the database system, a method of storing and recovering analysis information, comprising: a) extracting data from the database system using a filter; b) processing the extracted data to produce sorted datasets; c) processing sorted datasets to produce graphical objects; d) processing the graphical objects to produce analysis objects; and e) storing the analysis objects as separate file records in an analysis database in the network server. The step of processing the graphical objects to produce analysis objects further comprises i) processing the analysis objects to produce an interpretation file; and ii) processing the interpretation file to create a presentation assembly file. The step of storing the analysis object further comprises: assigning a record number (presentation chart record number) to each file record; copying each file record into a presentation file to produce a presentation chart file; creating a presentation assembly file from the presentation chart files; assigning a presentation assembly record number to each presentation assembly file; associating the presentation assembly file with a corresponding list of presentation chart record numbers.

The method of storing and recovering analysis information further comprising storing the database system on a network server. Preferably, the network server is an SQL server or similar relational database management system (RDBMS). Each analysis object preferably comprises a data chart file and a notes file. The data chart file represents uninterpreted results from the exercise of the computerized analysis procedure on data elements filtered from the database system. The notes file associated with the data chart file contains information tracking the (1) identifiers (not copies) of datasets recovered by the filter procedure as well as the (2) information on the versions of the applications software packages used to analyze and format the analysis. The step of processing sorted datasets to produce graphical objects further comprising creating label descriptors (indices) to a dataset to produce an individual application software output file. The step of processing the interpretation file to create a multi-chart presentation assembly file further comprising creating an image file, the image file comprising at least one analysis chart file. The presentation assembly file comprises a plurality of either data chart or presentation chart files. The method of processing the graphical objects further comprising: iii) assigning a presentation assembly record number to each presentation assembly file; iv) associating each presentation assembly file with a list of presentation chart record numbers; and v) associating each analysis chart record number with a corresponding presentation chart record number. Each label descriptor preferably points to an original dataset stored in the database system. Each label descriptor traces software processes applied to an original dataset to create an analysis chart file object. The method of processing graphical objects further comprising linking each label descriptor with corresponding datasets to identify the presentation assembly file that used the data identified by each of the label descriptors. Each dataset includes filter ranges to recover the dataset from the database containing raw data. Label descriptor information is preferably stored in a notes section associated with a data file in the analysis database. Notes sections for a presentation assembly file contain the record numbers used in its initial assembly, or in the alternate, it may include merged record numbers. In addition, presentation—or presentation assembly—file record precursors can be identified using a search feature. Similarly, the search feature can also identify all subsequent records that have incorporated a selected record file. Therefore all analytical objects can be tracked backward and forward through record numbers to original data files for which both filter settings—and analysis application versions—are available, making all records in the database traceable for audit reasons.

In another aspect, in a database system having information stored in the form of datasets, each dataset having a corresponding indices, a method of storing analysis information comprising a) extracting datasets from the database system; b) processing the extracted datasets to produced sorted data subsets; c) processing the sorted data subsets to produce graphical objects; d) processing the graphical objects to produce analysis objects; e) analyzing the analysis objects to produce an interpretation file (or presentation file); f) processing the interpretation file to create a presentation assembly file; g) storing the presentation assembly file in an assembly database; and h) linking each of the indices to identify the presentation assembly file that used the datasets identified by each of the indices.

In yet another aspect, a computer program product comprising a computer useable medium having computer program logic stored recorded thereon for enabling a processor in a computer system to organize data, the computer program product comprising: means for extracting filtered data from the database; means for processing the filtered data to produce sorted datasets; means for processing the sorted datasets to produce graphical objects; means for processing the graphical objects to produce analysis objects; means for analyzing the analysis objects to produce an interpretation file; means for processing the interpretation file to create a presentation assembly file; and means for storing the presentation assembly file in the database system.

In a further aspect, a system for storing and retrieving metadata from a database system, comprising: a communication network for data communication between a server and a plurality of client systems; a database coupled to the communication network for storing data supplied by each client system; the server receiving requests from each client system and querying the database for processing the requests; and each client system comprising a computer readable medium with computer program logic stored thereon for enabling a processor in the client system to organize data, the computer program logic comprising: filtering means for enabling the processor to filter data from the database; first processing means for enabling the processor to produce sorted datasets from the filtered data; second processing means for enabling the processor to produce graphical objects from the sorted datasets; a third processing means for enabling the processor to produce analysis objects from the graphical objects; analyzing means, for enabling the processor to produce an interpretation file having datasets with interpretations; a fourth processing means, for enabling the processor to process the interpretation file to produce a presentation file; means for invoking said processor to store the presentation file on the server system; and means for aggregating the presentation file with corresponding data stored on the server to produce a presentation assembly file.

In another aspect, a method of preserving database analysis for later recovery, comprising: (a) capturing database filter criteria as tracer labels for analysis conducted on a database; (b) passing the tracer labels through a series of computer applications used to perform the analysis; (c) maintaining the tracer labels in association with a presentation of the analysis; and (d) subsequently using the tracer labels to repeat the analysis.

In yet another aspect, an apparatus for preserving database analysis for later recovery, comprising: (a) means for capturing database filter criteria as tracer labels for analysis conducted on a database; (b) means for passing the tracer labels through a series of computer applications used to perform the analysis; (c) means for maintaining the tracer labels in association with a presentation of the analysis; and (d) means for subsequently using the tracer labels to repeat the analysis.

### BRIEF DESCRIPTION OF THE DRAWINGS

FIG. 1 is an exemplary schematic of the present invention implemented in a personal computer client-server environment;

FIG. 2 is another embodiment of the present invention illustrating an exemplary schematic of the present invention in an internet, or intranet, accessed server environment using the same analysis engines as in FIG. 1, but allowing users with workstations to access the server;

FIG. 3 illustrates a process flow schematic for the present invention producing analysis information for storing in the analysis database;

FIG. 4 is an exemplary dataflow diagram associated with the parts life database (PLDB) as shown in FIG. 3;

FIG. 5 is an exemplary user interface of a data filter used to query the parts life database (PLDB) of FIG. 3;

FIG. 6 is an exemplary user interface of a data filter for recovering previously stored reports, from a parts life database (PLDB) of FIG. 3, to construct and store presentations;

FIG. 7 is an exemplary user-interface to add externally created files to the parts life database (PLDB) system as shown in FIG. 3.

### DETAILED DESCRIPTION OF THE INVENTION

Definitions

A Data chart is defined as an individual graph or chart created by analysis applications, such as for example, Excel®, MINITAB®, and then stored as a read-only PowerPoint® file with a unique database record number. A Data chart cannot be modified or marked up by the analyst, or any other user, without first saving the modified chart as a Presentation chart with a new, unique record number.

A Presentation chart is an individual data charts which can be modified or marked up by the authoring analyst and then saved as a new database (DB) record in a single PowerPoint file. A Presentation chart can also result from a MERGE or any combination of Data charts and Presentation charts up to a maximum of four.

A Presentation assembly file is a grouping of selected PLADB records into a new PLADB record Powerpoint file. If Presentation charts or Presentation Assembly files are modified by the author, the modifications are saved with the same database record number. If Presentation charts or Presentation Assembly files are modified by any other user, they can only be saved as new records by the other user.

The PLADB record files are defined to have the following characteristics: (1) can be accessed using filtration of the database record listing; (2) can only be deleted or modified by a user who created them; (3) users can create analyses within their level of PLDB permission (i.e., permissions controlled at the data table level within the PLDB); each data chart has an appended notes page having information related to settings of the chosen data filters, versions of the PC applications used in the analysis, and parts used in the analysis may be stored. The notes information enables tracking the data used in analyzing datasets. It should be noted that the data charts themselves may not be modified, but may be as objects.

The PLADB presentation charts are defined to have the following characteristics: (1) previously saved data charts can be merged into PowerPoint presentation charts; (2) the presentation charts can be modified by the analyst like any general PowerPoint chart; (3) presentation charts may be saved as distinct PLADB records with a record number.

The PLADB presentation assembly files are defined to have the following characteristics: (1) presentation assembly files are selected groups of any PLADB records, which include any combination of: (i) data charts, (ii) presentation charts, and (iii) presentation assembly files. Externally prepared presentation files may also be saved as distinct PLADB record files in server 10.

This invention provides an enterprise memory of past analyses done by personnel no longer with an enterprise. The data filter information is captured, from a parts life database system (PLDB) system having datasets stored therein, as tracer labels for analysis conducted on the datasets through a series of computer applications. The filtered information is stored as business information presentations in a parts life analysis database (PLADB). The analysis database is preferably stored on an SQL server database with corresponding links to datasets located on the PLDB database. The present method provides a memory of past analyses that may be accessed at future times to provide an audit trail for both business decisions as well as for minimizing the processing time associated with redoing the analysis either with the original datasets or updated datasets. The PLADB helps a user to filter the available PLDB data, and create output in various formats, such as, for example, data lists in Excel, graphs of engine operating histories, histograms of discrete distributions, and Weibull predictions of part reliability.

Each file stored in the PLADB is assigned an analysis chart record number. When an analyst copies one or more analysis chart files from the analysis database to a presentation chart file, the analysis chart record numbers become associated with the presentation chart file. The presentation chart file is a medium to which the analyst adds his markups and commentaries to the results shown in the analysis chart file images. Combining a plurality of individual presentation chart files in a defined sequence creates a presentation assembly file. The indices associated with each analysis chart file used to trace the dataset are made up of two types: (1) those that identify the dataset, per se, and (2) those that trace the software processes applied to a respective dataset to create the analysis chart file object(s).

The locations in which the indices are stored while a dataset is being processed in an application software engine may vary from one application to another. Preferably, independent applications maintain an associated notes section in a file that is being processed. In a preferred embodiment, indices in the notes section are captured, even though it is possible to paste them directly on the analysis chart file itself. Keeping them as associated notes files, and merely allowing copying of the notes files assures the continued quality of the indices.

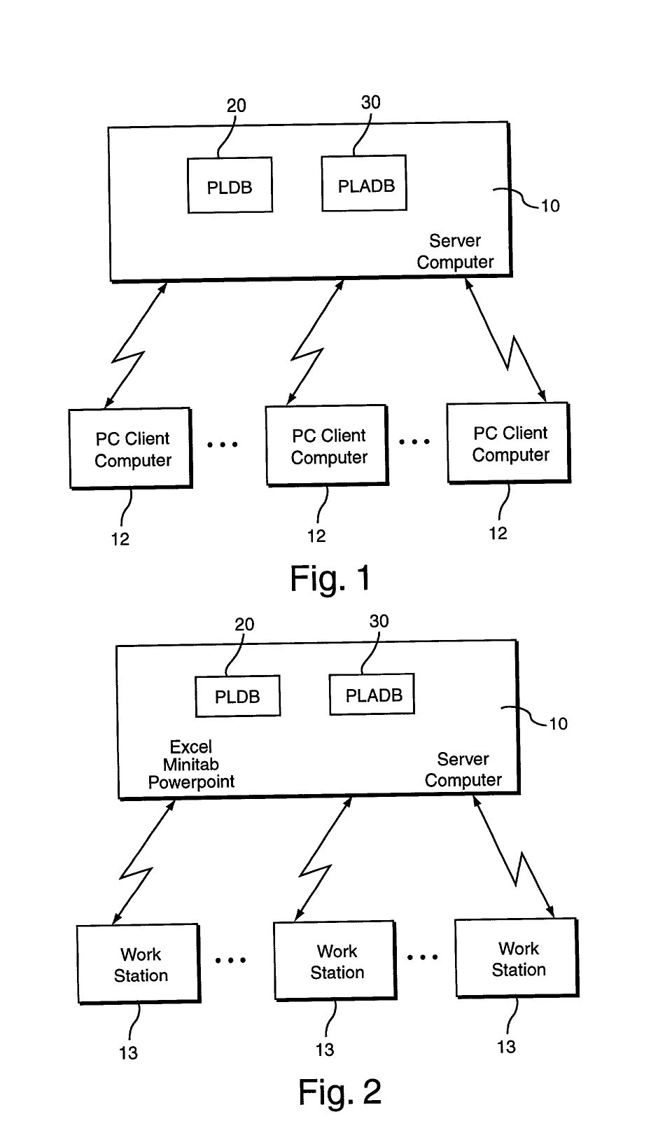

FIG. 1 shows an exemplary schematic of the present invention implemented in a client-server environment. A server computer generally indicated at 10 includes a database system such as, for example, parts life database (PLDB) 20. A plurality of client computer systems 12 are communicatively coupled and may be remotely located from server computer 10. A wire-line or wireless communication network may be adapted to communicatively couple client and server computers. Each client computer 12 may also communicative with server computer 10 via World Wide Web or Internet network. PLDB 20 is preferably stored on an MS-SQL server database 10. The PLDB 20 include such information as, for example, GT engine operations, part configuration histories, part condition after engine exposure, and top level service job information. The raw data stored in PLDB 20 is filtered and displayed through a PC client program stored on each client computer 12. Each client computer 12 may further loaded with applications such as, for example, Excel®, MINITAB®, PowerPoint®, and PLADB client program.

FIG. 2 shows an alternative embodiment in which the applications software packages may be accessed from the server network rather than from a PC as shown in FIG. 1. This approach allows users operating from workstations (i.e., no storage capability) to conduct similar type of analyses conducted by PC based users, either directly over the network or indirectly through the World Wide Web. Multiple users can be handled in this environment by a well-understood process of threading.

Security may be provided by permitted access to PLDB 20. Analyzed datasets from PLDB 20 are stored on server 10 in a parts life analysis database (PLADB) 30. The analysis data may be stored and recovered as presentation record files such as, for example, PowerPoint files, data charts, presentation charts, and presentation assembly files.

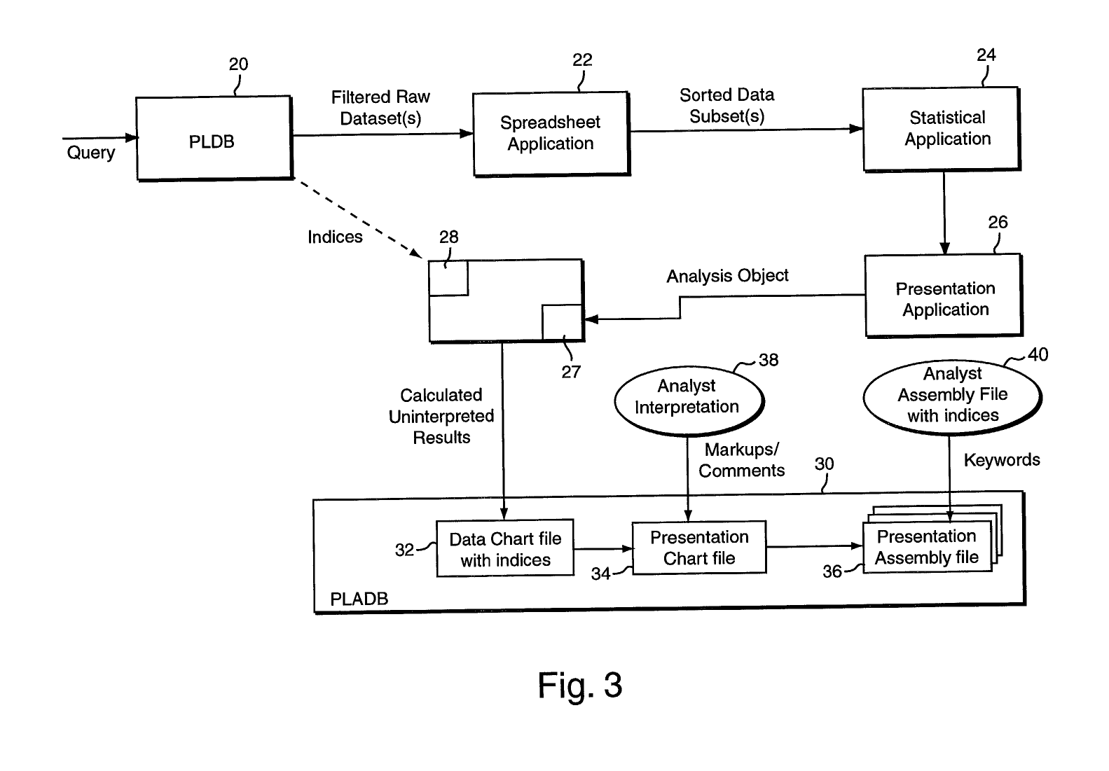

FIG. 3 shows an exemplary process flow schematic to compute the analysis results for storage and retrieval of information from PLDB 20. Each user located at a client computer 12 issues queries to the PLDB database 20. Queries are issued through an interface to filter the raw datasets stored in PLDB 20. The filtered information, generated in response to queries to PLDB 20, is input to a spreadsheet application as indicated at 22 to generate sorted data subsets. The spreadsheet application may be, for example, an MS Excel^{R} application. The sorted data subsets from the spreadsheet application 22 are fed to a statistical application program, such as, for example, MINITAB, as indicated at 24. The output from the statistical application 24 may be in the form of engine operation charts depicting engine operations and histograms showing distribution frequencies. The histograms may be related to, for example, part conditions or the number of hours that a part is exposed to. The output of statistical application 24 is provided to a presentation application software as indicated at 26. One of the advantages of using commercial applications to conduct these analyses is that these, or similar, applications are often available to all personnel in an organization as part of a “core load” of software for general use. This minimizes the need for unique training for this PLADB software, as well as obviating the need to program the application functions to meet the PLADB functional needs. Another advantage is that any new features that are added to this application software by its vendor are automatically made available to the PLADB updates, while usually being “backwardly” compatible and not requiring PLADB rewrites to access earlier available functionality.

The presentation application software 26 may be, for example, an application such as Powerpoint®. The presentation application software 26 receives information from the statistical application as indicated at 24 to create a presentation data file, referred to herein as “data chart file” as indicated at 27. Each data chart file includes an appended notes page having such information, as for example, settings of the chosen data filters in order to obtain filtered datasets from the PLDB 20, versions of the PC applications used in the analysis by a user, parts count used in the analysis, and a bar chart representing parts count. The appended notes information enables tracking of the datasets used in a user's analysis.

The analysis objects, created by presentation application 26, include data chart files along with the notes information and indices information. The analysis objects are stored in PLADB 30 located on server 10. Data chart files along with appended notes, indicated at 32, may be incorporated with user comments/markups to produce an output file generally referred to as a “presentation chart file” as indicated at 34. Each of these presentation chart files may be combined together to form a “presentation assembly file” at 36. Each presentation assembly file includes keywords along with indices information to link each presentation chart file with raw datasets stored in PLDB 20.

The data chart files and presentation chart files are saved as a separate record in PLADB 30, and aggregated with non-data files stored in PLDB 20 to provide a complete presentation assembly file. Each analysis chart file is assigned a PLADB record number. When a user copies one or more analysis chart files from PLADB 30 into a presentation chart file, the analysis chart record numbers become associated with the presentation chart files. The control of preparing any individual presentation chart files may reside either within a database software program, or may be controlled by the user and later entered into PLADB 30 via a user interface. PLADB 30 assigns the presentation assembly file with a presentation assembly record number, and associates with the presentation assembly record number a list of presentation chart file record numbers. Similarly, the analysis chart record numbers are associated with each presentation chart record number.

Each analysis chart file includes the results of processing the raw data from PLDB 20 through a sequence of independent application software programs. When an analysis chart file is copied into a presentation chart file, a user may add analyst interpretations, which may include such information as title, commentaries, etc. to the presentation chart file. PLADB 30 links the presentation assembly file to the indices used to describe the original dataset that is being processed, the original datasets being stored in PLDB 20. In addition, the link from PLADB also identifies all the presentation assembly files that use the datasets identified by the indices.

The dataset indices may include filter ranges that may be used to recover the datasets from PLDB 20. Such filters generally include desired ranges of data from known data fields in PLDB 20. The field filters may be combined using Boolean logic to arrive at a specified dataset. The filters may also contain such files as, for example, query date, author, and query agent. The process indices may also include the host database status such as, for example, DB engine, SW name, the region number, total stored data size, host computer name, etc., and the version sequence of each of the independent analysis software applications that the data was passed through. The locations in which the indices are stored while the dataset is being processed in an application software engine may vary from one application to another. However, most such independent applications maintain an associated notes section appended to a file that is being processed. The indices of the present invention are preferably captured in the notes section, though it may be possible to paste them directly on an analysis chart file itself. Storing the indices on the associated notes files, and only allowing copying without allowing modification of notes, assures the continued quality of the indices.

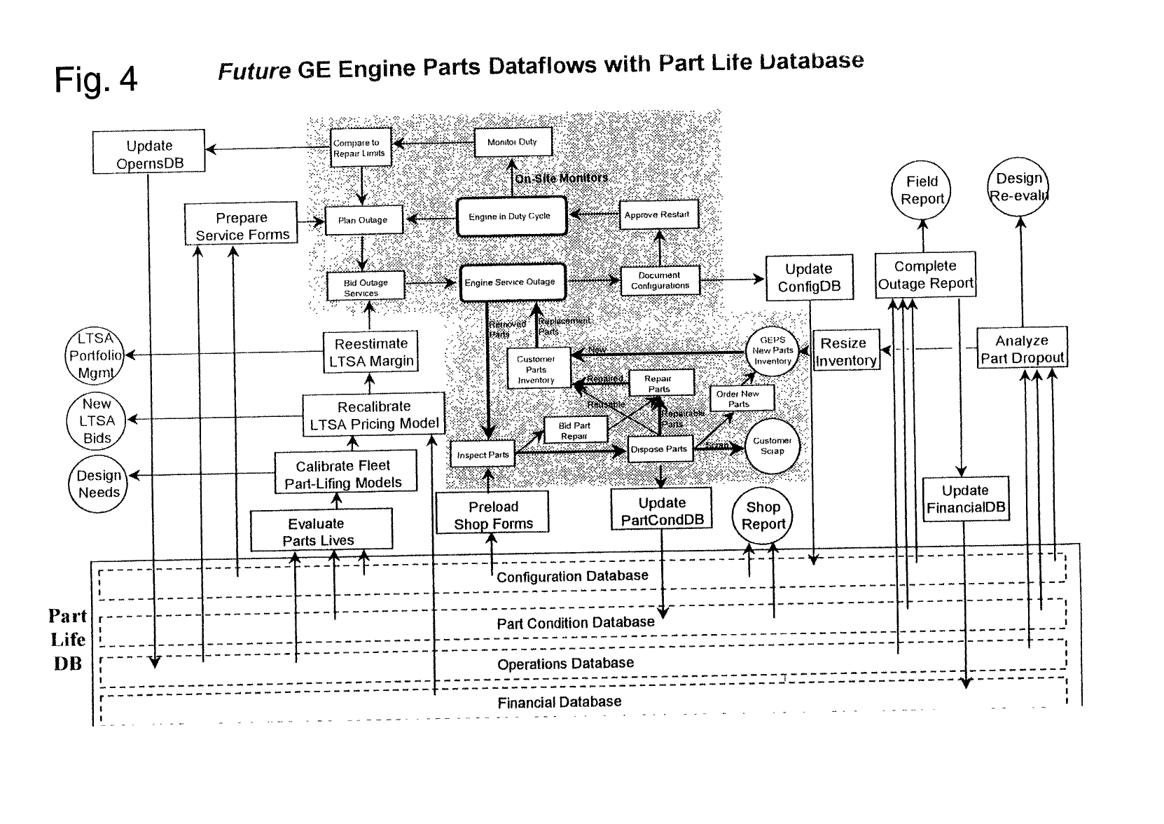

FIG. 4 shows an exemplary data flow diagram wherein information from various engine components is communicated to PLDB 20 (FIG. 3). PLADB 30 (FIG. 3) structure defined here enables a more detailed tracability that can be maintained over many years to provide a widely accessible corporate memory of the information used to make business decisions. Note that the PLADB accesses PLDB data, but that the storage location of the PLADB analyses and their product files need not be within the PLDB nor even on the same server, although the latter is desirable from good software architecture practice.

In another embodiment, analysis can be read on more confidently by new users on current datasets that are similarly filtered from PLDB 20. Thus, analyses that are repeated regularly to reveal new business information based on more recent data, may be duplicated with assurance. Should errors be later found in the application software engines that are used to process the datasets stored in PLDB 20, the data analysis can be repeated with obvious efficiency and confidence. The automatic handling of the indices associated with the datasets possibly minimizes errors by a user, particularly when several analyses are being performed simultaneously.

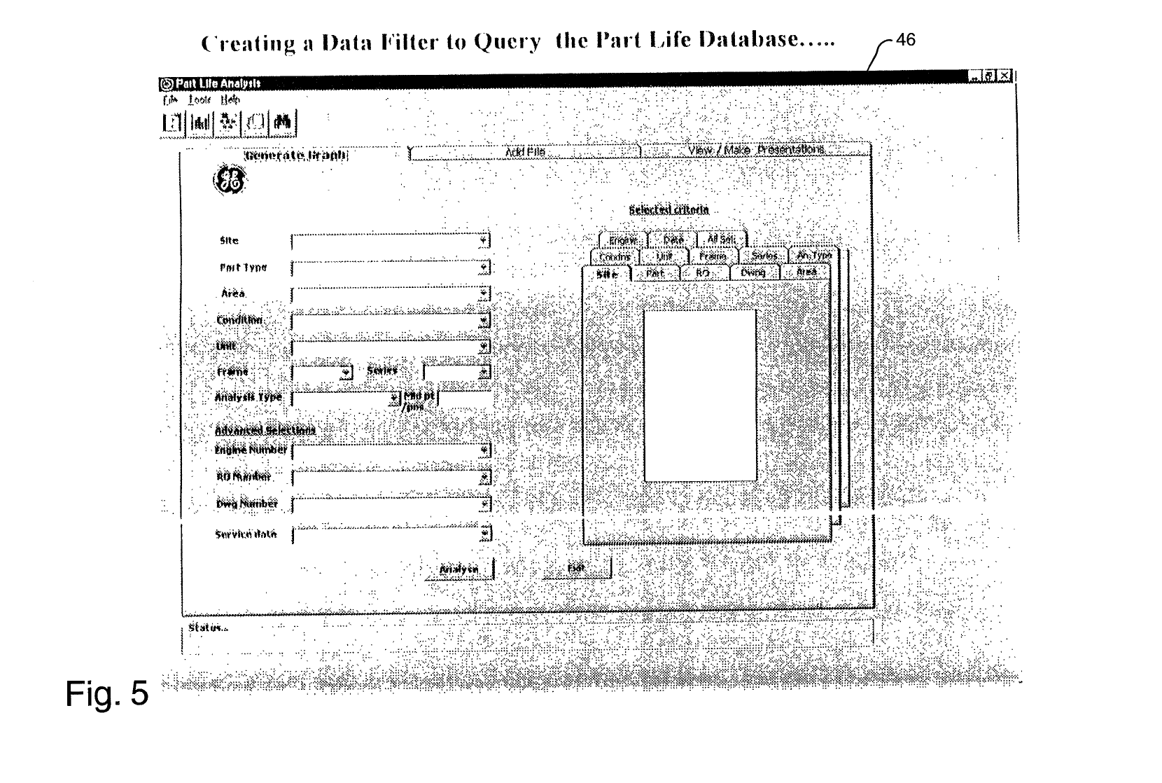

FIG. 5 shows a user interface 46 of a data filter for querying PLDB 20 (FIG. 3).

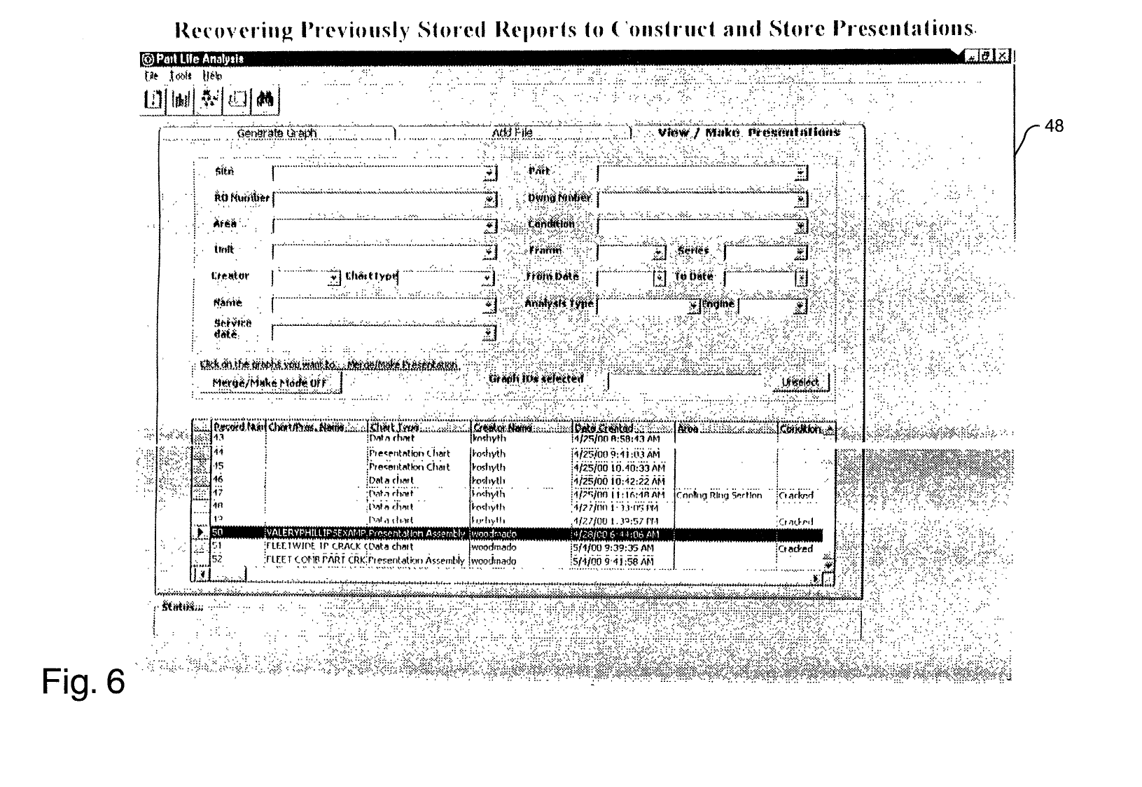

FIG. 6 shows a user interface 48 for recovering previously stored reports to construct and store presentations.

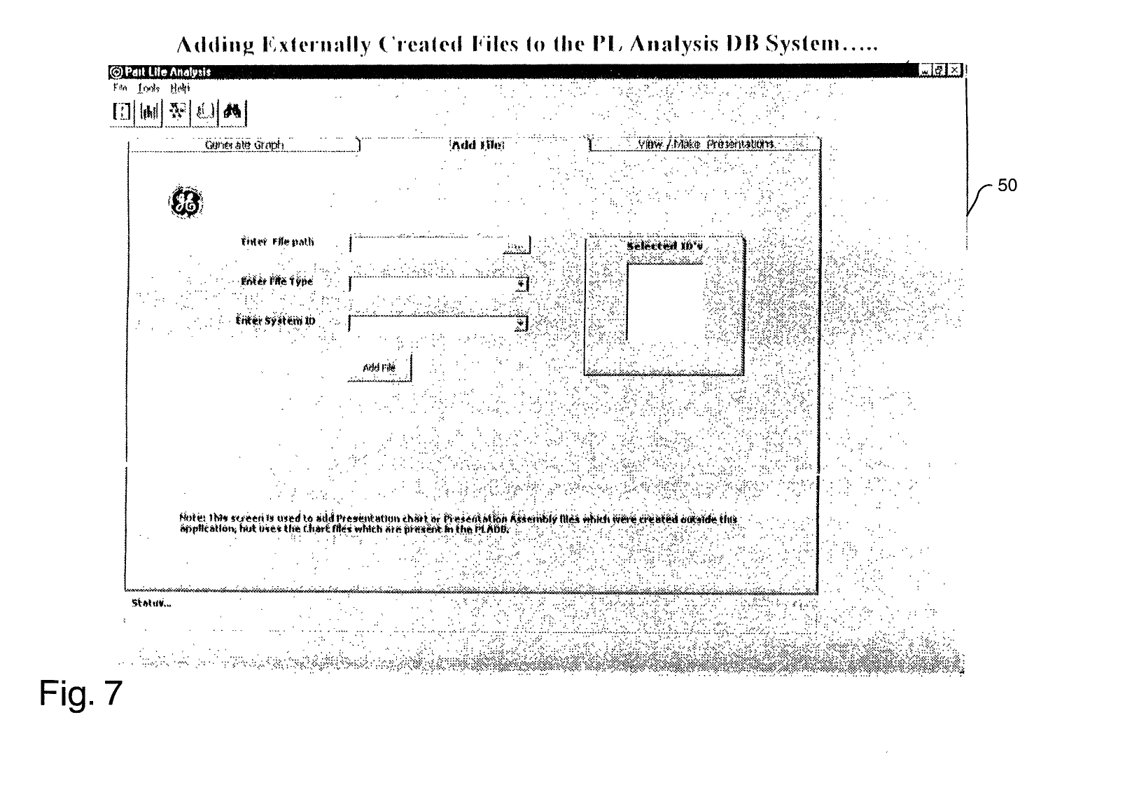

Referring to FIG. 7, there is shown a user interface 50 of a filter that is used to add externally generated files to PLDB 20 (FIG. 3). Interface 50 may be used to add presentation charts or presentation assembly files created outside the PLADB information control, but nevertheless use the chart files which are stored in PLADB 30 as PLADB record files by an analyst.

PLADB is constructed with sufficient tracers that enable either an analysis chart or a presentation assembly file can be recovered easily with a minimum of search efforts. This feature may be important to the maintenance of an audit trail for business decisions that are often driven by legal liability issues, as well as by good business practices to improve analyses processes. Further, analysis by new analysts may be performed on current datasets that are similarly filtered from a host database. Thus, analyses that are repeated regularly to reveal new business information based on more recent data can be duplicated with assurance as established analysis processes are used. Should errors be later found in the application software engines used to process the data, the data analysis can be repeated more quickly and confidently after replacing the earlier version with an improved version in the analysis procedure. The automatic handling of the indices associated with a dataset thus minimizes errors by the analyst, particularly when several analyses are being performed nearly simultaneously.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. For example, user access to analyses generated by authors with higher levels of PLDB data table permissions are currently allowed in the embodiment. This could easily be corrected by associating a security level with each data chart which would track that information and limit analysis record access to only those with that level of permission. The spirit of such changes is deemed to be included within the spirit and scope of the present claims.

What is claimed is:

1. A method of storing and recovering database analysis information, comprising:
a) extracting data from a database system;
b) processing the extracted data to produce sorted datasets;
c) processing sorted datasets to produce graphical objects;
d) processing the graphical objects to produce analysis objects; and
e) storing the analysis objects as separate file records.

2. The method of claim 1 wherein step (d) further comprising:
i) processing the analysis objects to produce an interpretation file; and
ii) processing the interpretation file to create a presentation assembly file.

3. The method of claim 1, wherein step (e) further comprising:
assigning a record number (presentation chart record number) to each said file record;
copying each said file record into a presentation file to produce a presentation chart file;
creating a presentation assembly file from said presentation chart file;
assigning a presentation assembly record number to each presentation assembly file; and
associating the presentation assembly file with a corresponding list of presentation chart record numbers.

4. The method of claim 1, further comprising:
f) storing the database system on a network server.

5. The method of claim 4, wherein said network server is an SQL server.

6. The method of claim 5, wherein said SQL server is a relational database management system (RDBMS).

7. The method of claim 2, wherein each analysis object comprises a data chart file and a notes file, the data chart file representing uninterpreted results from said database system.

8. The method of claim 1, wherein step (c) further comprising:
creating label descriptors (indices) to a dataset to produce an individual application software output file.

9. The method of claim 2, wherein step (ii) further comprising:
creating an image file, said image file comprising at least one analysis chart file.

10. The method of claim 2, wherein said presentation assembly file comprises a plurality of presentation chart files.

11. The method of claim 2, further comprising:
iii) assigning a presentation assembly record number to each presentation assembly file;
iv) associating each presentation assembly file with a list of presentation chart record numbers; and
v) associating each analysis chart record number with a corresponding presentation chart record number.

12. The method of claim 8, wherein each label descriptor identifies an original dataset stored in said database system.

13. The method of claim 8, wherein each label descriptor traces software processes applied to an original dataset to create an analysis chart file object.

14. The method of claim 11, further comprising:
linking each said label descriptor with corresponding datasets to identify the presentation assembly file that used the data identified by each of the label descriptors.

15. The method of claim 14, wherein each dataset includes filter ranges to recover the dataset from the database containing raw data.

16. The method of claim 14, wherein label descriptor information is stored in a notes section in a file in said analysis database.

17. In a database system having information stored in the form of datasets, each dataset having corresponding indices, a method of storing analysis information comprising:
a) extracting datasets from the database system;
b) processing the extracted datasets to produced sorted data subsets;
c) processing the sorted data subsets to produce graphical objects;
d) processing the graphical objects to produce analysis objects;
e) processing the analysis objects to produce an interpretation file;
f) processing the interpretation file to create a presentation assembly file;
g) storing the presentation assembly file in an assembly database; and
h) linking each of the indices to identify the presentation assembly file that used the datasets identified by each of the indices.

18. The method of claim 17, wherein step (d) further comprising:
i) processing the analysis objects to produce an interpretation file; and
ii) processing the interpretation file to create a presentation assembly file.

19. The method of claim 17, wherein step (g) further comprising:
i) assigning a record number (presentation chart record number) to each said file record;
ii) copying each said file record into a presentation file to produce a presentation chart file;
iii) creating a presentation assembly file from said presentation chart files;
iv) assigning a presentation assembly record number to each presentation assembly file; and
v) associating the presentation assembly file with a corresponding list of presentation chart record numbers.

20. The method of claim 17, further comprising:
storing the database system on a network server.

21. The method of claim 20, wherein said network server is an SQL server.

22. The method of claim 21, wherein said SQL server is a relational database management system (RDBMS).

23. The method of claim 18, wherein each analysis object comprises a data chart file and a notes file, the data chart file representing uninterpreted results from said database system.

24. The method of claim 17, wherein step (c) further comprising:
creating label descriptors (indices) to a dataset to produce an individual application software output file.

25. The method of claim 18 wherein, step (ii) further comprising:
creating an image file, said image file comprising a t least one analysis chart file.

26. The method of claim 18, wherein said presentation assembly file comprises a plurality of presentation chart files.

27. The method of claim 18, further comprising:
iii) assigning a presentation assembly record number to each presentation assembly file;
iv) associating each presentation assembly file with a list of presentation chart record numbers; and
v) associating each analysis chart record number with a corresponding presentation chart record number.

28. The method of claim 24, wherein each label descriptor points to an original dataset stored in said database system.

29. The method of claim 24, wherein each label descriptor traces software processes applied to an original dataset to create an analysis chart file object.

30. The method of claim 27, further comprising:
vi) linking each said label descriptor with corresponding datasets to identify the presentation assembly file that used the data identified by each of the label descriptors.

31. The method of claim 30, wherein each dataset includes filter ranges to recover the dataset from the database.

32. The method of claim 30, wherein label descriptor information is stored in a notes section in a file in said analysis database.

33. A system for recovering analysis data from a database system, comprising:
means for extracting filtered data from the database;
means for processing the filtered data to produce sorted datasets;
means for processing the sorted datasets to produce graphical objects;
means for processing the graphical objects to produce analysis objects;
means for analyzing the analysis objects to produce a interpretation file;
means for processing the interpretation file to create a presentation assembly file;
means for storing the presentation assembly file in said database system; and
means for linking the presentation assembly files with indices to identify datasets used to create the presentation assembly files.

34. A computer program product comprising a computer useable medium having computer program logic stored recorded thereon for enabling a processor in a computer system to organize data, said computer program product comprising:
means for extracting filtered data from the database;
means for processing the filtered data to produce sorted datasets;
means for processing the sorted datasets to produce graphical objects;
means for processing the graphical objects to produce analysis objects;
means for analyzing the analysis objects to produce an interpretation file;
means for processing the interpretation file to create a presentation assembly file; and
means for storing the presentation assembly file in said database system.

35. A system for storing and retrieving metadata from a database system, comprising:
a communication network for data communication between a server and a plurality of client systems;
a database coupled to said communication network for storing data supplied by each client system;
said server receiving requests from each said client system and querying said database for processing said requests; and
each said client system comprising a computer readable medium with computer program logic stored thereon for enabling a processor in said client system to organize data, said computer program logic comprising:
filtering means for enabling said processor to filter data from said database;
first processing means for enabling said processor to produce sorted datasets from said filtered data;
second processing means for enabling said processor to produce graphical objects from said sorted datasets;
a third processing means for enabling said processor to produce analysis objects from said graphical objects;
analyzing means, for enabling said processor to produce an interpretation file having datasets with interpretations;
a fourth processing means, for enabling said processor to process said interpretation file to produce a presentation file;
means for invoking said processor to store said presentation file on said server system; and
means for aggregating said presentation file with corresponding data stored on said server to produce a presentation assembly file.

36. A method of preserving database analysis for later recovery, comprising:
(a) capturing database filter criteria as tracer labels for analysis conducted on a database;
(b) passing said tracer labels through a series of computer applications used to perform said analysis;
(c) maintaining said tracer labels in association with a presentation of said analysis; and
(d) subsequently using said tracer labels to repeat said analysis.

37. An apparatus for preserving database analysis for later recovery, comprising:
(a) means for capturing database filter criteria as tracer labels for analysis conducted on a database;
(b) means for passing said tracer labels through a series of computer applications used to perform said analysis;
(c) means for maintaining said tracer labels in association with a presentation of said analysis; and
(d) means for subsequently using said tracer labels to repeat said analysis.
